(19) United States
(12) Patent Application Publication
(10) Pub. No.: US 2026/0197181 A1
(43) Pub. Date: Jul. 9, 2026

(54) ZERO TRUST TAGGING OF CLOUD OBJECTS

(71) Applicant: Cisco Technology, Inc., San Jose, CA (US)

(72) Inventors: William Mark Townsley, San Francisco, CA (US); Mark Alan Bakke, Maple Grove, MN (US)

(21) Appl. No.: 19/012,233

(22) Filed: Jan. 7, 2025

(51) Int. Cl. H04L 9/32

(52) U.S. Cl. CPC H04L 9/3247

(57) ABSTRACT

Techniques are described that enable zero trust routing of cloud objects across cloud service providers in multi-cloud networks. The techniques enabling customers to create customized tags for cloud objects, where the tags are signed by trusted application(s) or a network management system. The techniques enable the tags to be stored in a cloud object and deleted. The techniques enable invalid tags to be ignored such that traffic may continue to flow using the previous, valid tag. The techniques prevent customers from tampering or replaying tag values, thus improving network security by preventing customers from gaining access to networks they should not have access to.

### TECHNICAL FIELD

The present invention relates generally to cloud networking and more specifically to providing zero trust tagging of cloud objects across cloud service providers.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service provider (ISP) Networks that operate WANs to provide connectivity to individual users or enterprises, software-defined networks (SDNs), wireless networks, core networks, cloud networks, and so forth.

An example network is a public cloud service provider (CSP). For instance, a customer (e.g., a tenant, such as a company or an enterprise) environment can include a single CSP or multiple CPSs, such as AWS, Azure, Oracle, etc. The customer may use multiple CPS for a variety of reasons (e.g., specific features, mergers and acquisitions, dual-vendor policies, etc.). When using the CSPs, the customer may also still operate their private clouds and branches.

As an example, each CSP has its own way of tagging network elements (e.g., cloud objects). Tags can be placed on a variety of aspects such as general resources, a VPC, an instance, a subnet, etc. However, tags are not distributed across clouds, so tracking and mapping between clouds is difficult.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an environment in which a system provides an example multi-cloud mesh that provides a simplified mechanism for managing multi-cloud connectivity between CSPs.

FIG. 2A illustrates a flow diagram of an example system that enables customizable and signed tagging of cloud objects within the MCN using a trusted customer application, according to the techniques described herein.

FIG. 2B illustrates a flow diagram of an example system that enables customizable and signed tagging of cloud objects within the MCN, according to the techniques described herein.

FIG. 3A illustrates fields of an exemplary tag that the system may generate according to the techniques described herein.

FIG. 3B illustrates an exemplary user interface that may be displayed via the dashboard, as described herein.

FIG. 4 illustrates a flow diagram of an example system for providing zero trust tagging of cloud objects within a MCN, according to the systems and techniques described in FIGS. 1-3B.

FIG. 5 illustrates a component diagram of an example network management system, as described in FIGS. 1-4.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of cloud networking and more specifically to providing zero trust tagging of cloud objects across cloud service providers. For instance, the techniques described herein may relate to providing zero trust tagging of cloud objects in multi-cloud networks.

A method to perform the techniques described herein may include receiving input associated with a tag of a cloud object in the MCN, the cloud object being associated with a cloud account. The method may include determining, based in part on the input, that the input associated with the tag is valid. The method may include determining, based on the tag, one or more mappings between the tag and one of a tunnel or a classless inter domain routing (CIDR) group. The method may include determining, based on the one or more mappings, one or more virtual points of presence (vPoPs) within the MCN. The method may also include sending, to the one or more vPoPs, the one or more mappings.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

As noted above, the use of multiple CSPs introduces various complexities for customers. Some complexities may relate to managing a customer network over multiple cloud networks. One such complexity relates to connecting different workloads and CSPs. As each cloud system has different components, connecting between cloud system(s) and the customer's private clouds and branches is difficult. For instance, a customer may want to deploy an application in two separate CSPs (e.g., such as AWS and Azure). However, how the two CSPs are structured, perform tagging, name components, etc. can be very different. This is not only highly complex but requires specialty knowledge in networking for both CSPs to enable network elements from one CSP to connect to network elements from another CSP, resulting in a need to hire staff that specialize in each CSP. Accordingly, managing the customer network can be resource intensive, complex, and costly for the customer to track and maintain.

Another complexity arises when a portion of the customer accounts are received via an acquisition or when an application team starts up from scratch. In these instances, subnet address ranges (e.g., NATs) of the accounts can overlap or have other issues that need to be addressed before the accounts can access or connect to services within the customer's network. This results in a company requiring additional specialized teams to manually correct the overlap, as well as identify and establish new connections between the customer accounts, applications, and CSPs. This is not only time-consuming and complex to sort out, but results in various accounts lacking connections to company resources and services.

Additionally, complexities can relate to inconsistencies between the different CSPs. For instance, each CSP may have inconsistencies in the capabilities between each CSP and the sites of the customer. Each CSP may have differences in the limitations of components between each CSP and networking elements of the customer. One such limitation may relate to how each CSP tags various cloud objects. For instance, each CSP has differences in what elements a customer can tag, what groups (or users) a customer can tag, what traffic a customer can tag, how to name the tags, how the tags are tracked across the CSP, etc. As an example, tags can be placed on a variety of network elements within a CSP, such as general resources, a VPC, an instance, a subnet, etc. The CSPs may each have a different way to tag instances or VPCs, but not all CSPs have a way to tag a subnet. Further, for each CSP, a customer can decide which of the customer networks to connect in different ways. As an example, the customer may use a user interface to indicate they want to connect VPC1 to VNET2. However, where there are a large amount of VPCs/VNETs, such as in a customer network described above, this is difficult to track, especially where the VPCs or VNETs are dynamic (e.g., VPCs generated with terraform) and may come into and out of existence every day, every hour, etc. Accordingly, tracking tags across CSPs is difficult and a user is unable to define their own tags in a simple way that can be utilized in cross cloud platforms.

Moreover, each CSP has their own way of tagging things. For instance, tags can be placed on a variety of network elements (e.g., cloud objects) such as general resources, a VPC, an instance, a subnet, etc. in one CSP and one a different variety of network elements in another CSP. However, tags are not distributed across clouds, so tracking and mapping between CSPs is difficult, as is enforcement of tags and policies between CSPs. Further, within the MCN, a user may utilize a dashboard of a service provider to add or change tag values. However, this can result in the user gaining access to network(s) they shouldn't have access to. As an example, a policy associated with a tag may indicate that a set of user accounts may access traffic tagged as “finance” for a particular customer (e.g., such as an enterprise, organization, etc.). Another user within the organization or associated with another organization may have administration capabilities that enable the user to create a “finance” tag in association with a cloud object (e.g., VPC) at the other user's account, thereby enabling the other user to connect to or view information associated with the “finance” tag across CSPs, resulting a security vulnerability within the customer's network. That is, existing techniques may enable users to tamper with tag values and gain access to information and networks they should not be able to access, such as by replaying a previous tag value.

Accordingly, there is a need to provide a zero trust way to create and manage tags for cloud objects across CSPs in multi-cloud networks.

This disclosure describes techniques for providing zero trust tagging of cloud objects within multi-cloud networks. The techniques may relate to generating signed tags of cloud objects using a trusted application on a user device. In some examples, the techniques include receiving input associated with a tag of a cloud object in the MCN, the cloud object being associated with a cloud account. The techniques may include determining, based in part on the input, that the input associated with the tag is valid. The techniques may include determining, based on the tag, one or more mappings between the tag and one of a tunnel or a classless inter domain routing (CIDR) group. The techniques may include determining, based on the one or more mappings, one or more virtual points of presence (vPoPs) within the MCN; and sending, to the one or more vPoPs, the one or more mappings.

In some examples, the system includes virtual points of presence (vPoPs). In some examples, the vPoPs comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts.

In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. In some examples, the vPoPs may be configured to connect the tenancies (e.g., all of Tenant A together, All of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may comprise a dashboard. In some examples, the dashboard may comprise one or more application(s) and/or API(s) that are provided by a service provider of the multi-cloud mesh (e.g., such as Cisco) to enable a customer to interface with the network management system and generate tags for various cloud objects. In some examples, the dashboard may enable the user to provide input to create, edit, and/or delete tag(s). In some examples, the dashboard enables the customer to tag cloud object(s) across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the vPoPs that are tagged as “blue” may then be interconnected with each other, whether vPoP is connected via AWS or Azure, and/or whether the vPoP is connected to an on premises data center (e.g., such as via a catalyst switch or a Meraki switch).

In some examples, the NMS may store and track tags associated with the multi-cloud mesh and/or cloud objects. For instance, the NMS may store mappings between various tags, CSPs, cloud objects, identifier(s), etc. in a database of the multi-cloud mesh and/or in memory of the NMS. The NMS may update the mappings based on changes made to tag value(s). As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

In some examples, the system may comprise a tag component. In some examples, the tag component may be configured to generate and manage tags. For instance, the tag component may be incorporated as part of the NMS, included in a dashboard, and/or included as part application on a user device of a customer (e.g., outside of the multi-cloud mesh). For instance, the tag component may receive input from the dashboard. The tag component may be configured to use the input to create a signed tag associated with a cloud object. For instance, the customer may provide input that includes values for one or more fields (e.g., tag name, tag value, object ID, nonce value, etc.) of a tag. The cloud object(s) may include network elements such as VPCs, VNETs, subnet(s), instances, network interfaces, or any other object. The tag component may generate a signed tag based on the values input by the customer. In some examples, the signature may be generated by the tag component at the user device (e.g., such as by the application). In other examples, such as where the application is integrated as part of the NMS, the NMS may generate the signed tag via the tag component.

In some examples, the tag component may include one or more of the values (e.g., such as tag name, VPNID, nonce, etc.) in a signature for the signed tag. In some examples, a name of the entity or an identifier of the entity may also be included in the signature. In some examples, the tag may include a nonce value. The nonce value may be a value added by the customer or a value generated by a service provider of the multi-cloud mesh (e.g., Cisco). The signature may comprise a cryptographical signature and/or may be hashed using any suitable hashing technique. Accordingly, by including the one or more values in the signature of the tag, the tag component may ensure that the signature is unable to be copied from one network to another. For instance, by including the nonce value, the system may ensure that even where the same hashing algorithm is run with known values of the tag being the same, the hashed value of the signed tag will still be different. Accordingly, the system may provide the ability to trust cloud objects across the CSPs.

In some examples, the tag component may enable the user to edit one or more values of the tag. For instance, a user may update a value of one or more of the fields of the tag (e.g., such as the name, nonce value, etc.). As noted above, under existing techniques changing a value of a tag could provide access to network(s) the user should not have access to. For instance, a user may take a valid or previously used tag value and replay it, resulting in the user gaining access to networks and/or cloud objects they should not have access to.

Unlike existing techniques, by the tag component may, when a change to a tag value is made, determine whether the change is valid and authorized. For instance, the tag component may determine whether the change in the tag value will result in the user accessing a new network. In this example, the system may determine, based on network policies and/or security policies, whether the user is authorized to access the new network. Where the system determines that the user is not authorized to access the new network, the system may indicate that the change in the tag value is invalid. In this example, the system may ignore the new invalid tag and may continue to allow traffic from the cloud object using the previous valid tag. Additionally, the system may output an alert to the user via the dashboard indicating the new tag is invalid. Accordingly, the system may prevent users from other users of the MCN and/or cloud objects with IAM roles from changing tag values and gaining access to networks they shouldn't, thereby improving security within the MCN.

In some examples, such as where the tag component is implemented on a user device of a customer (e.g., as part of an application, etc.), the tag component may, once the tag is generated, send the tag to a cloud object (e.g., such as a VPC of the user running in a CSP) via an API (e.g., such as an AWS API) for storage and use. The VPC at the CSP may be associated with a customer account and may store the tag in memory and utilize the tag in connection with the cloud object (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new cloud object.

In some examples, the tag component may be configured to encrypt the tag signature using a private key, where the NMS or a validation system stores a corresponding public key used to decrypt the signature. In some examples, the tag component may be configured to utilize one or more machine learning and/or artificial intelligence models to generate the signed tags and/or encrypt the signed tags.

In some examples, the tag component may be configured or included as part of a trusted application. For instance, the trusted application may correspond to a third-party application that enables the user to write tags for cloud object(s) within the MCN. In some examples, the trusted application may include machine learning model(s) and/or artificial intelligence model(s).

In some examples, the tag component may be configured to read tags received and/or generated at the user device. For instance, the tag component may receive, via the dashboard, application, and/or cloud object, an indication of a new tag created by the user. The tag component may be configured to utilize the validation system to validate the tag.

In some examples, the system may comprise a validation system. For instance, the validation system may correspond to a third-party system that is outside of the multi-cloud mesh and/or a system that is integrated as part of the NMS and/or multi-cloud mesh. In some examples, the validation system may correspond to a certificate authority or other security system. In some examples, the validation system may store public key(s) associated with the tag(s) and/or application(s). The validation system may be configured to receive a signed tag, a cryptographical signature, and/or an encrypted signature of a tag from the tag component. The validation system may provide, to the tag component and based on the signature, a public key associated with the application. The tag component may validate that the tag is signed by the particular application and verify that the NMS can trust the application.

In some examples, the system may distribute mapping(s) to vPoP(s) once an application and/or tag is validated. For instance, the system may store mappings between the tags of incoming tunnel(s) and/or classless inter domain routing groups (CIDR(s)) to equivalent VPNID, SGTs, etc. In some examples, the CIDR to tag mappings may comprise CIDR to SGT mappings. For instance, a CIDR to SGT mapping may refer to the process of associating a specific network IP address range (defined using CIDR notation) with a Security Group Tag (SGT) value, which may allow network traffic originating from that IP range (e.g., particular subnet or range of IP addresses) to be identified and treated as belonging to a particular security group on within the multi-cloud mesh 102. A tunnel to tag mapping may refer to one or more tags assigned to traffic traversing a particular tunnel interface and may enable granular policy enforcement based on the tunnel connection, rather than just the source or destination IP addresses.

In some examples, the system may distribute the mapping to relevant vPoP(s) (e.g., a subset of the vPoP(s) that will receive traffic associated with a particular tag), such that not all vPoP(s) store mappings for every cloud object, thereby reducing memory and storage utilized by the multi-cloud mesh.

In this way, the system may enable users to customize tags of cloud objects utilizing a dashboard or trusted customer application. By utilizing tag signatures that include fields of the tag within the signature, the system may prevent a customer from tampering or changing tag values and gaining access to networks they should not have access to. By storing the signed tags within the network elements (e.g., VPCs) at the cloud service provider, the system reduces the amount of memory and network bandwidth utilized by the NMS and multi-cloud mesh 102 for tracking and managing tags, thereby improving scalability of the multi-cloud mesh 102 and enabling integration in environments where network elements are created and destroyed frequently (e.g., such as terraformed environments). Moreover, by utilizing nonce values as well as other tag values when generating the signed tag, the system may ensure that even where the same hashing algorithm is run and where the known fields of a tag have the same values, the hash of the tag may still generate different hash values, thereby generating different signed tags, thereby enabling the system to more securely validate and track tags within the MCN.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

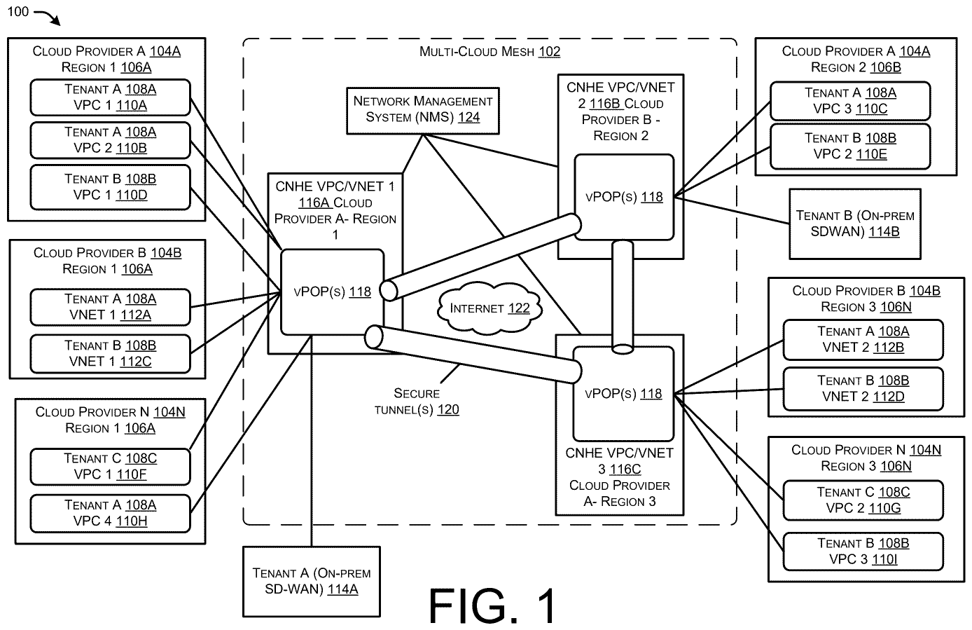

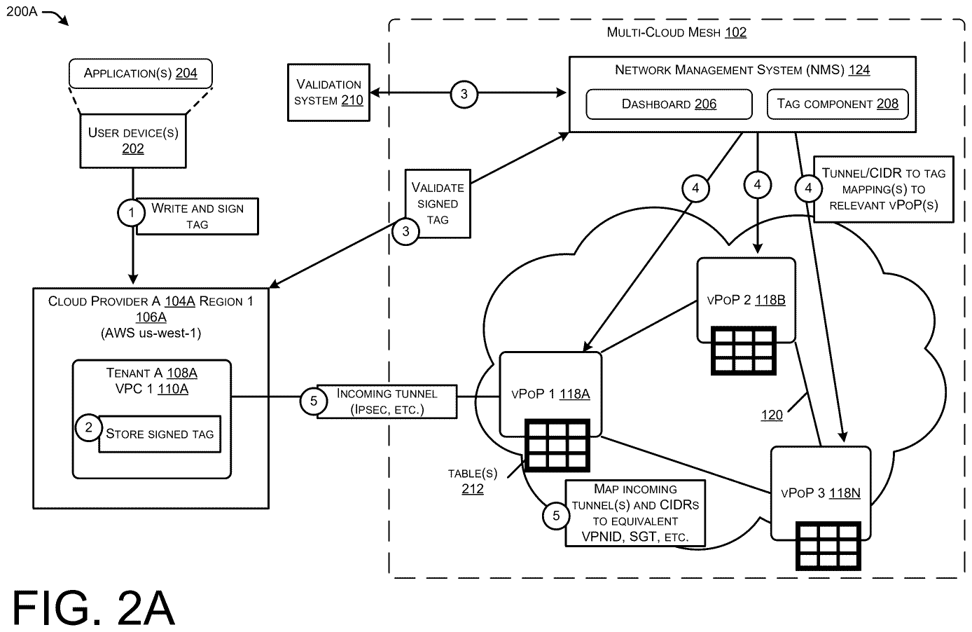

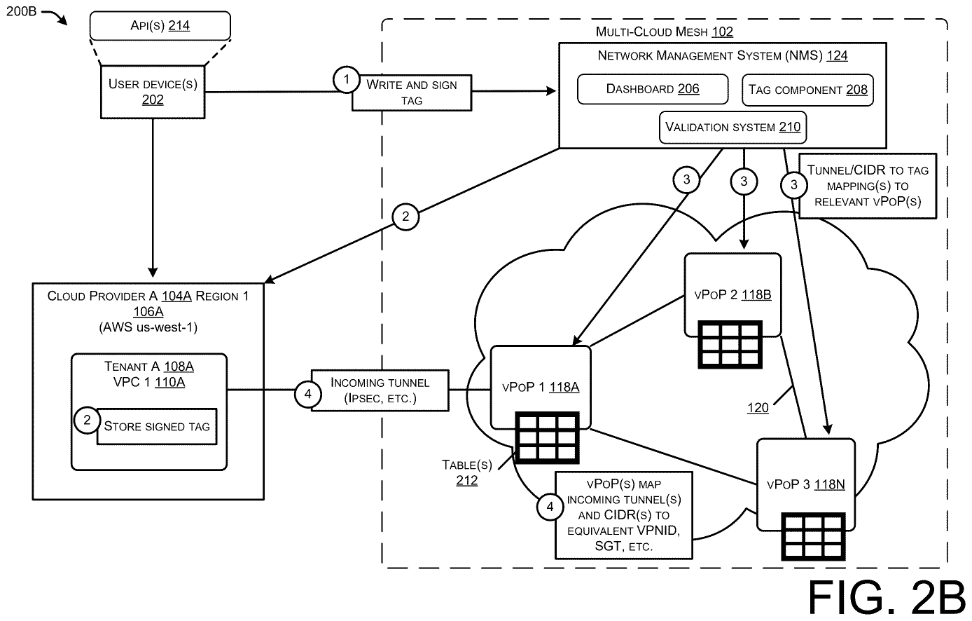

FIG. 1 illustrates a system-architecture diagram of an environment in which a system 100 provides an example multi-cloud mesh that provides a simplified mechanism for managing multi-cloud connectivity and tagging between CSPs. While the system 100 shows an example multi-cloud mesh, it is understood that any of the components of the system may be implemented on any device, network, and/or any cloud-based service provider. Moreover, while the system 100 illustrates a network management system, it is understood that any of the components illustrated in FIGS. 2-6 may be implemented and/or incorporated in the multi-cloud mesh. Moreover, it is understood that while the examples described herein are related to multi-cloud networking, the techniques described herein are not limited to multi-cloud networks and may apply to any network or industry that utilizes tagging.

In some examples, the system 100 may include multi-cloud mesh 102. As used herein, multi-cloud mesh 102 may be referenced as the “MCN” and vice versa. The multi-cloud mesh 102 may include one or more networks implemented by any viable communication technology, such as wired and/or wireless modalities and/or technologies. The multi-cloud mesh 102 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, SD-WANs, SDNs—and/or any combination, permutation, and/or aggregation thereof. The multi-cloud mesh 102 may include devices, virtual resources, or other nodes that relay packets from one network segment to another by nodes in the computer network. The multi-cloud mesh 102 may include multiple devices that utilize the network layer (and/or session layer, transport layer, etc.) in the OSI model for packet forwarding, and/or other layers. In some examples, the multi-cloud mesh 102 corresponds to an SD-WAN overlay.

The system 100 may comprise cloud provider(s) (e.g., cloud provider A 104A, cloud provider B 104B, cloud provider N 104N), which may correspond to various CSPs. For instance, cloud provider A 104A may represent AWS, cloud provider B 104B may represent Azure, and cloud provider N 104N may represent GPC.

Each cloud provider may have one or more site(s) associated with a particular region (e.g., region 1 106A, region 2 106B, region 3 106N, etc.). For instance, region 1 106A may represent a western portion of a particular geographic location (e.g., country, state, city, or any other suitable geographic location), region 2 may represent a central portion of the geographic location, and region 3 106N may represent an eastern portion of the geographic location.

The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the packet-forwarding networks may not be located in explicitly defined data centers but may be located in other locations or buildings. In some examples, the site(s) comprise network device(s), which may correspond to any computing device, routers, switches, computers, or any other type of network device. Edge device(s) may comprise routers, switches, access points, stations, radios, and/or any other network device.

Each cloud provider may be multi-tenanted. For instance, cloud provider A 104A in region 1 106A may provide services to Tenant A 108A and Tenant B 108B. Each tenant may correspond to a different customer (e.g., such as an enterprise, organization, private entity, etc.). As illustrated, tenant A 108A may utilize services provided by cloud provider A 104A, cloud provider B 104B, and cloud provider N 104N. For instance, the services may include virtual private clouds (VPC(s) 110) or virtual networks (VNET(s) 112) that each respective tenant pays the cloud service provider for. As illustrated, the services provided by each cloud provider to each respective tenant is located outside of the multi-cloud mesh 102.

As illustrated in FIG. 1, cloud provider A 104A may run various VPCs for each tenant in each region. For instance, for tenant A 108A, cloud provider A 104A may run VPC 1 110A and VPC 2 110B in region 1 106A and VPC 3 110C in region 2 106B. For tenant B, cloud provider A 104A may also run VPC 1 110D in region 1 106A and VPC 2 110E in region 2. Similarly, cloud provider B 104B may be configured to provide VNET services to tenants. As illustrated for tenant A 108A, cloud provider B 104B may run VNET 1 112A in region 1 106A and VNET 2 112B in region 3 106N. For tenant B, cloud provider B 104B may run VNET 1 112C in region 1 106A and VNET 2 112D in region 3 106N. Cloud provider N may also be configured to provide VPC services. For instance, for tenant C 108C, cloud provider N 104N may provide VPC 1 110F in region 1 106A and VPC 2 110G in region 3. For tenant A, cloud provider N 104N may provide VPC 4 110H in region 1. For tenant B, cloud provider N may provide VPC 3 110I in region 3.

Additionally, each tenant may have one or more physical location(s). For instance, Tenant A 108A may have an on-premises SD-WAN 114A. In some examples, the tenant A on-premises SD-WAN 114A may comprise a site or physical data center of tenant A. In some examples, the tenant A on-premises SD-WAN 114A may utilize features or protocols to connect to the multi-cloud mesh 102, such as Meraki and/or AutoVPN. Tenant B 108B may have an on-premises SD-WAN 114B. In some examples, the tenant B on-premises SD-WAN 114B may comprise a site or physical data center of tenant B and may be located in region 2. In some examples, the tenant B on-premises SD-WAN 114B may utilize features or protocols to connect to the multi-cloud mesh 102, such as Cisco's Catalyst IPsec and/or ISR.

The multi-cloud mesh 102 may comprise network management system (NMS) 124. The NMS 124 may correspond to a system that has complete visibility into the fabric of a given network. In some examples, the NMS 124 may comprise one or more controllers, one or more processors, memory, one or more APIs, one or more applications, one or more components, etc. In some examples, and as described in greater detail below, the NMS 124 may be configured to generate cloud formation templates and vPoP(s) 118. As illustrated in FIG. 1, the NMS 124 may be connected to one or more CNHE VPC/VNET(s) 116 that comprise vPoP(s) 118, such that the NMS 124 can monitor, manage, and update each vPoP.

The CNHE VPC/VNET(s) 116 may correspond to a VPC or a VNET that is owned and/or managed by a service provider of the NMS (e.g., such as Cisco). As illustrated in FIG. 1, each CNHE VPC/VNET may be deployed within a particular cloud service provider and/or region. For instance, CNHE VPC/VNET 1 116A may run in cloud provider A region 1, CNHE VPC/VNET 2 116B may run in cloud provider B region 2, and CNHE VPC/VNET 3 116C may run in cloud provider A region 3. Accordingly, where cloud provider A represents AWS, CNHE VPC/VNET 1 116A and CNHE VPC/VNET 3 116C may represent instances of VPCs running in AWS. Where cloud provider B represents Azure, CNHE VPC/VNET 2 116B may represent instances of a VNET running in Azure. While the CNHE VPC/VNET(s) are illustrated as being run in different cloud providers, it is understood that a single CSP may be used or additional CSPs may be used.

As illustrated in FIG. 1, the vPoP(s) 118 in CNHE VPC/VNET 1 116A is configured to connect to each VPC and VNET running in cloud provider A 104A, cloud provider B 104B, and cloud provider N 104N in region 1 106A. Additionally, the vPoP(s) 118 in CNHE VPC/VNET 1 116A may be configured to connect to Tenant A on-premises SD-WAN 114A using various protocols. The vPoP(s) 118 in CNHE VPC/VNET 2 116B is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols. The vPoP(s) 118 in CNHE VPC/VNET 3 116C is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols.

As illustrated, the vPoP(s) 118 are connected using secure tunnel(s) 120, which may represent encrypted data tunnels or tunnels created using any secure tunneling protocol. In some examples, the secure tunnel(s) 120 may be associated with a connection determined by a tenant, such that traffic from different tenants may be routed according to different protocols. Further, as illustrated, the vPoP(s) may be configured to communicate over the internet 122 or any other suitable network connection (e.g., core(s), 100 GB core, etc.).

In some examples, the vPoP(s) 118 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the multi-cloud mesh 102, the NMS 124 is configured to handle software upgrades, security tickets, etc. on behalf of the customer, such that the customer does not need to see or handle updates or security tickets for thousands of accounts.

In some examples, the vPoPs 118 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the vPoP(s) 118 and/or NMS 124 may be configured to keep one or more of data traffic, routes, statistics, etc. of different tenants separate from each other. For instance, the vPoP(s) 118 may be configured to store table(s) that comprise mappings between various tag(s) of cloud object(s), group(s), etc. and incoming connection(s). In some examples, the vPoP(s) 118 may be configured to connect traffic associated with each of the tenancies (e.g., all of Tenant A together, All of Tenant B together, etc.). In some examples, the vPoP(s) may be configured to connect a subset of the traffic for a particular tenancy based on a particular tag (e.g., connect all of Tenant A traffic tagged with a particular SGT group and/or originating from a particular cloud object together). Each vPoP may be configured to transmit data to each other over the internet 122, or other cores (e.g., such as a 100 GB core). Accordingly, the system may be configured to provide a per-customer topology between the vPoPs that is automated, provides flexibility in the types of tunnels, improved throughput, flexibility in the number of tunnels used (e.g., single or multiple tunnels), and/or provides balancing across the tunnels when needed (e.g., such as to get around administration limitations).

Thus, the multi-cloud mesh 102 may be configured to provide a connectivity first architecture (versus a security first architecture that runs everything through a firewall). As used herein, “connectivity first” means some of the security features of the multi-cloud mesh 102 is based on the connections selected by each tenant. For example, tenant A 108A can choose to connect VPC 1 110A and VPC 3 110C, but nothing else. In this example, the NMS 124 may distribute the routes for connecting VPC 1 110A and VPC 3 110C and may ensure that traffic sent/received by VPC 1 110A is to/from VPC 3 110C and vice versa. In some examples, the NMS 124 may distribute stateless firewalls to edge device(s) within the multi-cloud mesh 102, such that the techniques may not need to provide a central service all the time.

FIG. 2A illustrates a flow diagram of an example system 200A that enables customizable and signed tagging of cloud objects within the MCN using a trusted customer application, according to the techniques described herein. In some instances, one or more of the steps or elements of system 200A may be performed by one or more devices (e.g., NMS 124, user device(s) 202, VPC 1 110A, etc.) that include one or more processors and one or more non-transitory computer-readable media storing computer-executable instructions that, when executed by the one or more processors, cause the one or more processors to perform operations of system 200A. In some examples, the example system 200A may correspond to an example use case where a customer application and/or a cloud application write a tag for a cloud object and the NMS 124 consumes and verifies the tag.

The system 200A includes user device(s) 202, which may comprise a laptop, tablet, or any other computing device of a user (e.g., such as a network administrator of a tenant). The user device(s) 202 may include one or more application(s) 204 (or API(s) that are configured to interface with application(s) and/or NMS 124). The application(s) 204 may correspond to third-party application(s) configured to interface with a dashboard 206 and/or cloud object(s) (e.g., such as VPC 1 110A, or other network elements) of one or more CSPs (e.g., such as cloud provider A 104A. The application(s) 204 may enable the user to create, edit, and/or manage tag(s) within the MCN. For instance, in the illustrated system 200A, the application(s) 204 may correspond to a customer application associated with cloud provider A 104A, that enables the user to manage an account (e.g., Tenant A 108A account, such as an AWS account or application) with the CSP. In some examples, the application(s) 204 may perform one or more of the functionalities of the tag component 208 and/or incorporate one or more features of the tag component 208 and/or dashboard 206 to enable the creation and updating of signed tags for cloud object(s).

At “1”, the system may write and generate a signed tag. For instance, the application(s) 204 may write and generate the signed tag based on input from a user. The input may comprise value(s) for one or more fields of the tag, which may be displayed via a dashboard 206 (e.g., such as an AWS dashboard, etc.). For instance, the application(s) 204 may interface (e.g., such as via an API) with the dashboard 206 to provide a user interface that enables the user to manage tags. As described in greater detail below, the application(s) 204 may sign the tag using one or more of the values and/or encrypt the signature using a private key. In some examples, the signed tag is associated with a cloud object (e.g., subnet, VPC, VPN, instance(s), network interface(s), etc.) within a particular CSP (e.g., cloud provider A 104A). In this example, the application(s) 204 may not be validated by the NMS 124 but still are able to write tags within the MCN.

At “2”, the system may store the signed tag in a network element (e.g., VPC 1 110A). In some examples, the signed tag is stored in memory of cloud provider A 108A in association with the network element of the user (e.g., Tenant A 108A VPC 1 110A). In some examples, the signed tag is viewable by other application(s) running within the MCN and/or dashboard 206. In some examples, the application(s) 204 may send the signed tag to the network element for storage via an API.

At “3”, the system may validate the signed tag. In some examples, validating the signed tag may validate the application(s) 204 as a trusted application. For instance, the NMS 124 may receive and/or consume the signed tag associated with the cloud object. In some examples, the dashboard and/or tag component 208 may be configured to read the signed tag form the memory of the Tenant A account via an API associated with cloud provider A 104A (e.g., such as an AWS API). The system may access validation system 210 in order to validate the signed tag. For instance, the NMS 124 and/or tag component 208 may request a public key and/or certificate associated with application(s) 204 from the validation system 210. The NMS 124 may determine the certificate to request based on one or more values included in fields of the signed tag. The validation system 210 may retrieve the public key, certificate, etc. for the NMS 124 and/or tag component 208. The NMS 124 and/or tag component 208 may use the public key to decrypt the signature of the tag and verify that the application(s) 204 signed the tag. In some examples, the NMS 124 and/or tag component 208 may utilize a hashing algorithm to decrypt the signature. Once decrypted the system may compare the values in the signature to determine whether an identifier of the entity (e.g., the application) and/or a value of the tag is included in the signature and matches the value(s) and/or identifier stored by the NMS 124. Where there is a match, the system may determine that the application(s) 204 signed the tag. Where the system determines the application(s) 204 signed the tag, the NMS 124 may determine that the application(s) 204 is a trusted application and may store an indication of trusted status in association with identifier(s) of the application(s) 204 in memory and/or a database of the NMS 124.

At “4”, the system may, in response to determining the application(s) 204 can be trusted, distribute tunnel/CIDR to tag mapping(s) to relevant vPoP(s) 118 within the multi-cloud mesh 102. For instance, the tag component 208 may determine the relevant vPoP(s) based on identifying a subset of vPoP(s) within the multi-cloud mesh 102 that hand traffic associated with one or more tags. In the illustrated system 200A, the tag component 208 may distribute the mappings to vPoP 1 118A, vPoP 2 118B, and vPoP 3 118N, however additional or fewer vPoPs may be selected. In some examples, vPoP 1 118A, vPoP 2 118B, and vPoP 3 118N may store the mappings in table(s) 212. The table(s) 212 may be stored in memory of the vPoP(s) 118 and/or VPCs that the vPoPs are running in.

At “5”, the system may receive, at vPoP 1 118A, an incoming tunnel connection between VPC 1 110A of Tenant A 108A. The incoming tunnel may comprise an IPsec tunnel and may include one or more tags. vPoP 1 118A may map, based on accessing the table(s) 212, the incoming tunnel to equivalent VPNID(s), SGT(s), and/or other tag(s) associated with a particular cloud object, tenant, etc. For instance, the vPoP 1 118A may form the connection with VPC 1 110A based on the signed tag being included in the table(s) 212 and indicated as valid, thereby enabling the vPoP 1 118A to group and route traffic according to the mappings.

In some examples, the user device(s) 202 and/or other device(s) (such as a console user (not shown)) associated with a second user may attempt to change a value of the signed tag. In this example, the second user may change the name of the signed tag and may store the updated tag in the VPC 1 110A. In this example, the NMS 124 may, via the dashboard and the validation system 210, determine whether the change to the tag name is valid, such as by accessing one or more policies associated with identifier(s) of the other user. Where the NMS 124 determines the change is invalid, the NMS 124 may store an indication that the updated tag name is invalid and may ignore the invalid tag, such that the NMS 124 may prevent the other user and/or console device(s) from connecting to and/or viewing information related to the invalid tag.

In some examples, the user device(s) 202 and/or other device(s) (such as a console user (not shown)) associated with a second user may attempt to delete a signed tag. In this example, the NMS 124 may allow the second user to delete the signed tag associated with application(s) 204.

In this way, the system may enable users to customize tags of cloud objects utilizing a trusted customer application. By utilizing tag signatures that include fields of the tag within the signature, the system may prevent a customer from tampering or changing tag values and gaining access to networks they should not have access to. By storing the signed tags within the network elements (e.g., VPCs) at the cloud service provider, the system reduces the amount of memory and network bandwidth utilized by the NMS and multi-cloud mesh 102 for tracking and managing tags, thereby improving scalability of the multi-cloud mesh 102 and enabling integration in environments where network elements are created and destroyed frequently (e.g., such as terraformed environments). Moreover, by utilizing nonce values as well as other tag values when generating the signed tag, the system may ensure that even where the same hashing algorithm is run and where the known fields of a tag have the same values, the hash of the tag may still generate different hash values, thereby generating different signed tags, thereby enabling the system to more securely validate and track tags within the MCN.

FIG. 2B illustrates a flow diagram of an example system 200B that enables customizable and signed tagging of cloud objects within the MCN, according to the techniques described herein. In some instances, one or more of the steps or elements of system 200B may be performed by one or more devices (e.g., NMS 124, user device(s) 202, VPC 1 110A, etc.) that include one or more processors and one or more non-transitory computer-readable media storing computer-executable instructions that, when executed by the one or more processors, cause the one or more processors to perform operations of system 200B. In some examples, the example system 200B may correspond to an example use case where a user creates a signed tag for a cloud object via the dashboard 206 of the NMS 124.

For instance, the user device(s) 202 may access the dashboard 206 of the NMS 124 via one or more API(s) 214. The API(s) 214 may be configured to provide output to a user interface on the user device(s) 402. The system may include the multi-cloud mesh 102, which includes the NMS 124. The system may also include VPC(s) 110 or VNET(s) 112 of a customer (e.g., the tenant of user device(s) 202) that are running within region 1 106A of cloud provider A 104A. While not illustrated, it is understood that vPoP 118 is included as part of a CNHE (e.g., CNHE VPC/VNET(s) 116) described herein.

At “1”, the system may write and generate a signed tag. For instance, the API(s) 214 may interface with dashboard 206. The dashboard 206 may write and generate the signed tag based on input from a user of the user device(s). The input may comprise value(s) for one or more fields of the tag, which may be displayed via a dashboard 206 (e.g., such as an AWS dashboard, etc.). As described in greater detail below, the dashboard 206 may sign the tag using one or more of the values and/or encrypt the signature using a private key. In some examples, the signed tag is associated with a cloud object (e.g., subnet, VPC, VPN, instance(s), network interface(s), etc.) within a particular CSP (e.g., cloud provider A 104A).

At “2”, the system may store the signed tag in a network element (e.g., VPC 1 110A). In some examples, the signed tag is stored in memory of cloud provider A 108A in association with the network element of the user (e.g., Tenant A 108A VPC 1 110A). In some examples, the signed tag is viewable by other application(s) running within the MCN and/or dashboard 206. In some examples, the API(s) 214 and or the dashboard 206 may send the signed tag to the network element for storage. As noted above, the NMS 124 may store the signed tag and/or mapping(s) associated with the signed tag. In this example, as the NMS 124 generated the signed tag, the NMS 124 does not need to verify that an application on the user device(s) 202 is trusted. By validating the application(s) 204, the NMS 124 may enable connection(s) to be formed between the application(s) 204 and/or cloud object(s) and the multi-cloud mesh 102 to provide access to information associated with the signed tag.

At “3”, the NMS 124 may distribute tunnel/CIDR to tag mapping(s) to relevant vPoP(s) 118 within the multi-cloud mesh 102. For instance, the tag component 208 may determine the relevant vPoP(s) based on identifying a subset of vPoP(s) within the multi-cloud mesh 102 that hand traffic associated with one or more tags. In the illustrated system 200B, the tag component 208 may distribute the mappings to vPoP 1 118A, vPoP 2 110B, and vPoP 3 110N, however additional or fewer vPoPs may be selected. In some examples, vPoP 1 118A, vPoP 2 110B, and vPoP 3 110N may store the mappings in table(s) 212. The table(s) 212 may be stored in memory of the vPoP(s) 118 and/or VPCs that the vPoPs are running in within the multi-cloud mesh 102. In some examples, the CIDR to tag mappings may comprise CIDR to SGT mappings. For instance, a CIDR to SGT mapping may refer to the process of associating a specific network IP address range (defined using CIDR notation) with a Security Group Tag (SGT) number, essentially allowing network traffic originating from that IP range to be identified and treated as belonging to a particular security group on within the multi-cloud mesh 102. A tunnel to tag mapping may refer to one or more tags assigned to traffic traversing a particular tunnel interface and may enable granular policy enforcement based on the tunnel connection, rather than just the source or destination IP addresses.

At “4”, the system may receive an incoming tunnel (e.g., such as an IPsec tunnel or other suitable tunnel protocol) from VPC 1 110A. an incoming tunnel connection between VPC 1 110A of Tenant A 108A. The incoming tunnel may comprise an IPsec tunnel and may include one or more tags. vPoP 1 118A may map, based on accessing the table(s) 212, the incoming tunnel to equivalent VPNID(s), SGT(s), and/or other tag(s) associated with a particular cloud object, tenant, etc. For instance, the vPoP 1 118A may form the connection with VPC 1 110A based on the signed tag being included in the table(s) 212 and indicated as valid, thereby enabling the vPoP 1 118A to group and route traffic according to the mappings.

In some examples, the user device(s) 202 and/or other device(s) (such as a console user (not shown)) associated with a second user may attempt to change a value of the signed tag. In this example, the second user may change the name of the signed tag and may store the updated tag in the VPC 1 110A. In this example, the NMS 124 may, via the dashboard and the validation system 210, determine whether the change to the tag name is valid, such as by accessing one or more policies associated with identifier(s) of the other user. Where the NMS 124 determines the change is invalid, the NMS 124 may store an indication that the updated tag name is invalid and may ignore the invalid tag, such that the NMS 124 may prevent the other user and/or console device(s) from connecting to and/or viewing information related to the invalid tag.

In some examples, the user device(s) 202 and/or other device(s) (such as a console user (not shown)) associated with a second user may attempt to delete a signed tag. In this example, the NMS 124 may allow the second user to delete the signed tag associated with application(s) 204.

In this way, the system may enable users to customize tags of cloud objects utilizing a dashboard of the NMS 124. By utilizing tag signatures that include fields of the tag within the signature, the system may prevent a customer from tampering or changing tag values and gaining access to networks they should not have access to. By storing the signed tags within the network elements (e.g., VPCs) at the cloud service provider, the system reduces the amount of memory and network bandwidth utilized by the NMS and multi-cloud mesh 102 for tracking and managing tags, thereby improving scalability of the multi-cloud mesh 102 and enabling integration in environments where network elements are created and destroyed frequently (e.g., such as terraformed environments). Moreover, by utilizing nonce values as well as other tag values when generating the signed tag, the system may ensure that even where the same hashing algorithm is run and where the known fields of a tag have the same values, the hash of the tag may still generate different hash values, thereby generating different signed tags, thereby enabling the system to more securely validate and track tags within the MCN.

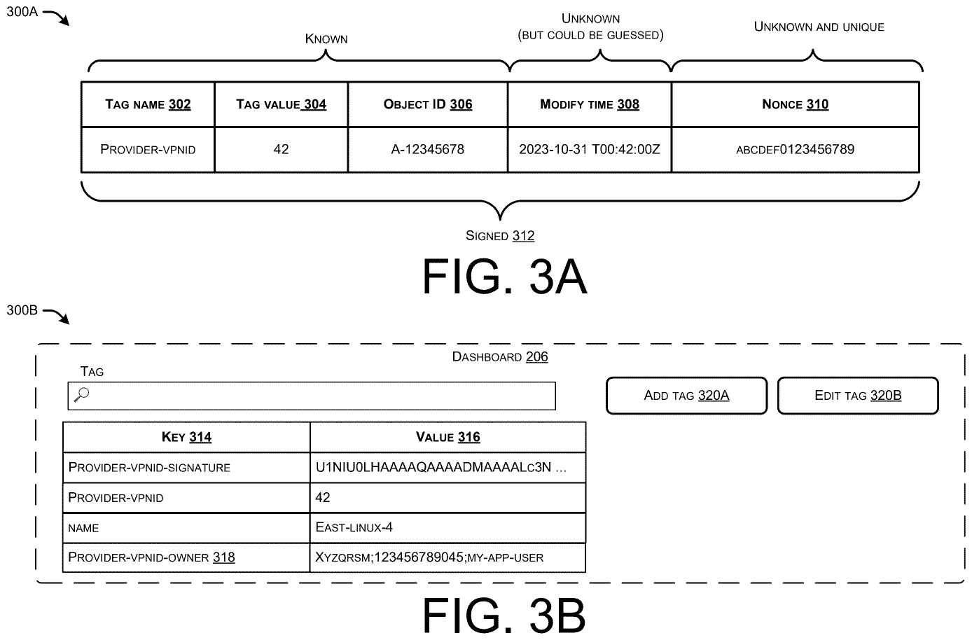

FIG. 3A illustrates fields an exemplary tag 300A that the system may generate according to the techniques described herein. For instance, the tag 300A may be generated based on receiving input to the dashboard 206 and/or an application 204 and read by the dashboard 206 via an API. As illustrated, the tag 300A may include one or more fields that a user may provide value(s) for. The fields may include, but are not limited to, a tag name 302, tag value 304, object ID 306, modify time 308, and/or nonce 310.

The tag 300A may comprise one or more fields with values that are “known” (e.g., visible to other application(s) and/or the dashboard 206 via API(s)). The tag name 302 may comprise any name the user wishes (e.g., alphanumeric, symbols, “1”, “blue”, etc.) and is associated with a particular cloud object. For instance, in the illustrated example, the tag name 302 is “provider-vpnid” (e.g., such as “cisco-vpnid”, etc.). The tag value 304 may comprise a value mapped to the particular cloud object. For instance, the tag value 304 comprises “42” which represents an identifier associated with the tag name and/or the cloud object. In some examples, the user may enter the value for the tag value 304. In other examples, the tag value 304 is generated by the NMS 124. The object ID 306 may comprise a value associated with the instance of the cloud object or an identifier of the VPC. In some examples, the object ID 306 is generated by the system and/or based on an identifier generated when the VPC or cloud object is created.

The tag 300A may include a field that is unknown, but could be guessed. As used herein, a field is “unknown” where it is not visible to other application(s) 204 within or outside of a CSP and/or dashboard 206. For instance, the tag 300A may include a modify time 308 that can be used to provide an added layer of security. The modify time 308 comprises a modification time of the tag 300A. For instance, the modify time 308 may correspond to a time when the tag 300A was created or updated by the system. In some examples, the modify time 308 may correspond to a time stamp and may be signed and/or tracked by the NMS 124. As noted above, the modify time 308 may be guessed, such as by another user. Accordingly, the tag 300A may include one or more additional modifier fields and/or nonce values.

The tag 300A may also include a field that is unknown and unlikely to be guessed. For instance, the tag 300A may include one or more nonce 310 values. The nonce 310 may be input by the user and/or generated by the NMS 124. The nonce 310 value may be any numeric, alphanumeric, symbolic, etc. value. By including the nonce 310 value in the tag of a cloud object, the system may utilize the nonce 310 when hashing the tag 300A. Accordingly, where another user does not know or have the nonce value, the device will be unable to hash the tag 300A. Accordingly, even where the same hashing algorithm is performed at different devices, the nonce value may ensure that different tags will hash to different values.

In some examples, one or more of the fields of the tag 300A may be signed 312. For instance, individual fields may be signed 312 separately and/or in combination with other fields. A portion of the tag 300A may be signed. In some examples, the entire tag 300A may be signed. As noted above, the signature may comprise a cryptographical signature and may utilize one or more of the fields of the tag 300A. For instance, the signature may be generated by hashing the tag name 302, tag value 304, and nonce 310 value. In some examples, the signature may include an entity identifier (not shown), which may be included in a field of the tag 300A. For instance, the entity identifier may comprise a name of the entity hosting the cloud object, a name of the user and/or application generating the tag, or any other suitable identifier associated with creating the tag 300A. For instance, where multiple applications on the user device(s) 202 can write tags, the tag 300A may include an owner ID (e.g., such as a source ID) that indicates a particular certificate associated with the user and/or source to validate by the NMS 124. In this example, multiple applications on the user device(s) may write tags within the MCN once validated by the NMS 124. Accordingly, where multiple applications can write tags on a user device, the dashboard 206 may include this field to enable the NMS 124 to determine which certificate to validate in association with the tag 300A. Thus, the system may prevent replay of previously used, valid tag values by mapping the tag 300A and tag value(s) to the owner ID/source ID, such that the old value cannot be replayed by a different application on the same user device, different user device, or even by the same application at a later time.

Accordingly, the system may enable a user to create and sign tags within a cloud provider that are customizable and secure. The system may validate the application(s) in order to ensure an application is trusted, to prevent tampering and prevent another user from changing tag values and gaining access to networks they should not have access to within the MCN.

FIG. 3B illustrates an exemplary user interface 300B that may be displayed via the dashboard 206. For instance, the user interface 300B may be displayed on a user device, such as user device(s) 202. In some examples, the user interface 300B may provide information associated with one or more tags created by the user and/or associated with the user. For instance, the user interface 300B includes a search bar that enables the user to provide input associated with a particular tag. Where the user inputs a value of a field of a tag (e.g., such as a tag name 302), the dashboard 206 may display the one or more fields associated with the tag in a table. The table may include key 314 and value 316 columns. The key 314 column may be associated with the tag name 302 and/or one or more of the fields. The value 316 column may comprise value(s) associated with each respective key 314 of the tag 300A.

As illustrated, the user interface 300B may display a tag name 302 “provider-vpnid” as a key 314, with “42” being the associated value 316 (e.g., the tag value 304). The “provider-vpnid-signature” key 314 may have an associated value 316 that includes the cryptographic signature of the tag 300A. In some examples, the key 314 may comprise an encrypted signature value associated with the tag 300A.

The user interface 300B may also include a key314 associated with a provider-vpnid-owner 318. In this example, the provider-vpnid-owner may include an associated value 316 comprising an indication of a source identifier, a user account, an application identifier, etc. associated with a user (e.g., such as tenant A 108A).

The user interface 300B may include additional selectable elements (e.g., such as an add tag 320A button and/or an edit tag 320B button) that the user may select to add, edit, or delete a tag. Additional or fewer elements may be included in the user interface 300B. Accordingly, it is understood that features displayed in the dashboard 206 are not limited to those shown in FIG. 3B.

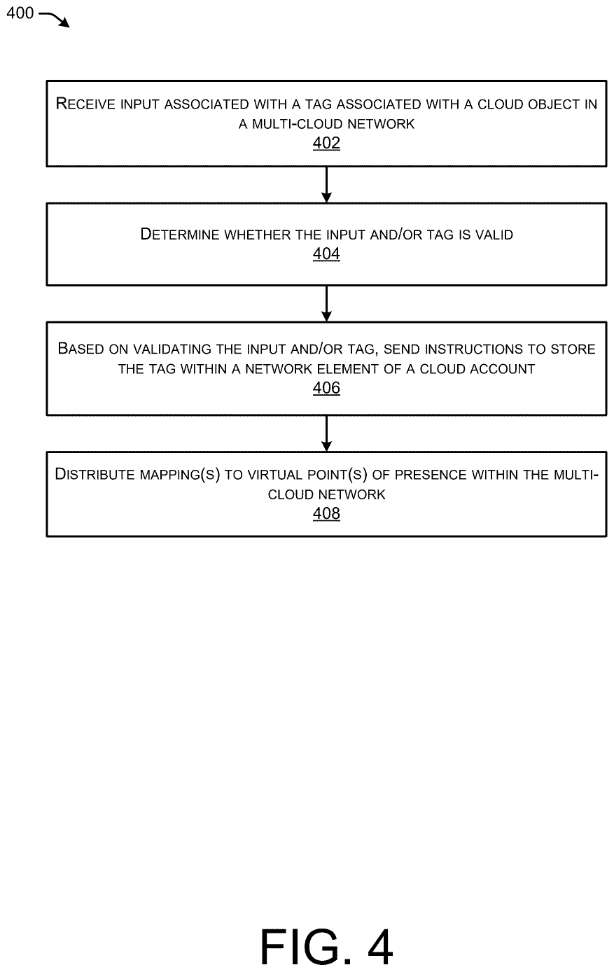

FIG. 4 illustrates a flow diagram of an example system 400 for providing zero trust tagging of cloud objects within a MCN, according to the systems and techniques described in FIGS. 1-3B. In some instances, one or more of the steps of system 400 may be performed by one or more devices (e.g., the NMS 124, user device(s) 202, etc.) that include one or more processors and one or more non-transitory computer-readable media storing computer-executable instructions that, when executed by the one or more processors, cause the one or more processors to perform operations of system 400.

At 402, the system may receive input associated with a tag of a cloud object in a multi-cloud network. For instance, the system may receive input via an application, such as application(s) 204 and/or via dashboard 206.

In some examples, the cloud object comprises one of a virtual private cloud, a virtual network, a network interface, an instance, or a subnet associated with the cloud account. In some examples, the tag comprises one or more fields including a tag name, a tag value, a time stamp, an object identifier, an entity identifier, or a nonce value. In some examples, the input may be associated with creating a tag. In this example, the tag is generated and signed by an application associated with a cloud service provider of the cloud account, wherein generating the tag comprises: receiving second input via the application comprising values associated with the one or more fields; and signing, by the application, the one or more fields of the tag to generate a cryptographical signature. In some examples, the cryptographical signature is based on hashing the tag name, cloud object identifier, and an identifier of an entity.

At 404, the system may determine whether the input and/or tag is valid. For instance, the system may receive the input from an application on a user device, such as application(s) 204. The input may be to create a tag associated with a cloud object. In some examples, determining the input is valid may comprise reading, by a network management system (NMS) of the MCN and from the cloud account, a signature of the tag; validating, based on accessing a verification system, the signature of the tag as being generated by the application; and based on validating the signature, storing an indication that the application is a trusted application in association with the tag.

At 406, the system may, based on validating the input and/or tag, determining mapping(s). For instance, in response to determining an application is a trusted application and/or that an update to a tag is valid, the system may identify mapping(s) between the tag and relevant tunnel(s), CIDR(s), and/or other tags within the MCN. In some examples, the system may determine relevant vPoP(s) to distribute the mapping(s) to. For instance, the mappings may comprise CIDR to tag mappings, such as CIDR to SGT, subnet to SGT, tunnel to SGT,

At 408, the system may distribute mapping(s) to virtual point(s) of presence within the multi-cloud network. For instance, the system may store mappings between the tags of incoming tunnel(s) and/or classless inter domain routing groups (CIDR(s)) to equivalent VPNID, SGTs, etc. In some examples, the CIDR to tag mappings may comprise CIDR to SGT mappings. For instance, a CIDR to SGT mapping may refer to the process of associating a specific network IP address range (defined using CIDR notation) with a Security Group Tag (SGT) value, which may allow network traffic originating from that IP range (e.g., particular subnet or range of IP addresses) to be identified and treated as belonging to a particular security group on within the multi-cloud mesh 102. A tunnel to tag mapping may refer to one or more tags assigned to traffic traversing a particular tunnel interface and may enable granular policy enforcement based on the tunnel connection, rather than just the source or destination IP addresses. The system may identify relevant vPoP(s) to distribute the mapping(s) to based on connection(s) and/or traffic associated with the tag.

In some examples, after distributing the mapping(s), the vPoP(s) may store the mapping(s) in table(s) 212. The system may receive, by a vPoP, a request to form a new tunnel or a new CIDR with the cloud object, the request comprising the tag; determine, by the vPoP, that the tag is mapped to the new tunnel or the new CIDR; and form, by the vPoP, a secure connection with the cloud object. For instance, the system may form the secure connection to the vPoPs using one or more secure tunneling protocols (e.g., such as IPsec, BGP, site-to-site VPN, or any other suitable protocol).

In some examples, the system may receive second input comprising an instruction to edit the tag and generate an updated tag associated with the cloud object. The system may determine, based on the second input, that the updated tag is invalid. The system may refrain from distributing the updated tag to the one or more vPoPs and the system may enable traffic flow between the cloud object and the MCN using the tag. In some examples, the system may determine the updated tag is invalid is based on or more of: a value of one or more fields in the updated tag being replayed or associated with a previously used value; a role of a user providing the input; or a violation of a security policy associated with the value of the updated tag or the role of the user. In some examples, the system may generate an alert associated with the updated tag, the alert indicating the updated tag is invalid; and send the alert to a user device for display.

In this way, the system may enable users to customize tags of cloud objects utilizing a dashboard or trusted customer application. By utilizing tag signatures that include fields of the tag within the signature, the system may prevent a customer from tampering or changing tag values and gaining access to networks they should not have access to. By storing the signed tags within the network elements (e.g., VPCs) at the cloud service provider, the system reduces the amount of memory and network bandwidth utilized by the NMS and multi-cloud mesh 102 for tracking and managing tags, thereby improving scalability of the multi-cloud mesh 102 and enabling integration in environments where network elements are created and destroyed frequently (e.g., such as terraformed environments). Moreover, by utilizing nonce values as well as other tag values when generating the signed tag, the system may ensure that even where the same hashing algorithm is run and where the known fields of a tag have the same values, the hash of the tag may still generate different hash values, thereby generating different signed tags, thereby enabling the system to more securely validate and track tags within the MCN.

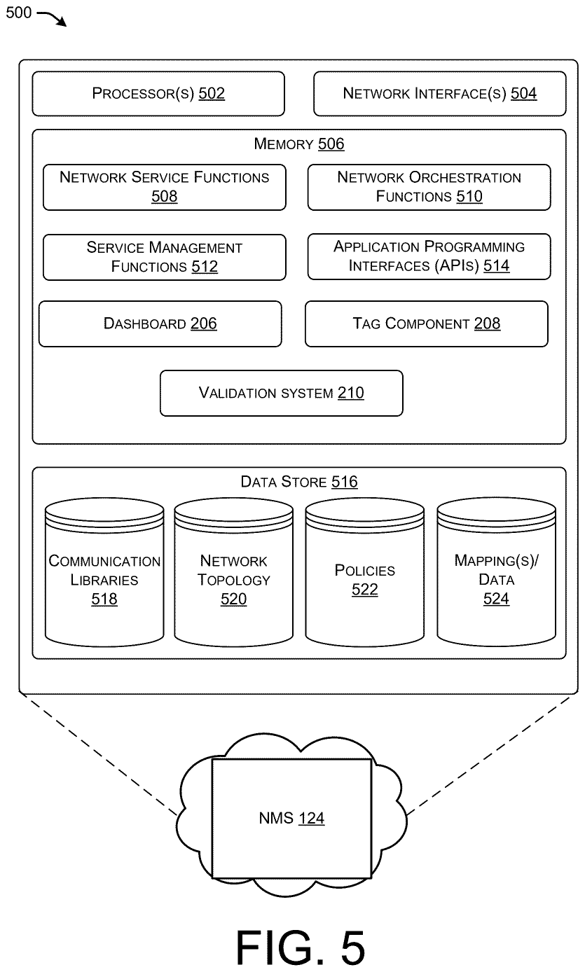

FIG. 5 illustrates a component diagram 500 of an example NMS 124, as described in FIGS. 1-4. In some instances, one or more of the components of the NMS 124 may run on and/or include one or more computing devices in, or associated with, the MCN (e.g., a single device or a system of devices, such as a NMS 124, user device(s) 202, etc.). Generally, the NMS 124 may include a programmable controller that manages some or all of the controller activities of the multi-cloud mesh 102 and/or MCN and manages or monitors the network state using one or more centralized control models.

As illustrated, the NMS 124 may include, or run on, one or more hardware processors 502 (processors), one or more devices, configured to execute one or more stored instructions. The processor(s) 502 may comprise one or more cores. Further, the NMS 124 may include or be associated with (e.g., communicatively coupled to) one or more network interfaces 504 configured to provide communications with network device(s), the edge device(s), and other devices, and/or other systems or devices in the multi-cloud mesh 102 and/or MCN and/or remote from the multi-cloud mesh 102 and/or MCN. The network interfaces 504 may include devices configured to couple to personal area networks (PANs), wired and wireless local area networks (LANs), wired and wireless wide area networks (WANs), SDCI's, and so forth. For example, the network interfaces 504 may include devices compatible with any networking protocol.

The NMS 124 may also include memory 506, such as computer-readable media, that stores various executable components (e.g., software-based components, firmware-based components, etc.). The memory 506 may generally store components to implement functionality described herein as being performed by the NMS 124. The memory 506 may store one or more network service functions 508, such as a slicing manager, a topology manager to manage a topology of the multi-cloud mesh 102, a host tracker to track what network components are hosting which programs or software, a switch manager to manage switches of the multi-cloud mesh 102, a process manager, and/or any other type of function performed by the NMS 124.

The NMS 124 may further include network orchestration functions 510 stored in memory 506 that perform various network functions, such as resource management, creating and managing network overlays, programmable APIs, provisioning or deploying applications, software, or code to hosts, and/or perform any other orchestration functions. Further, the memory 506 may store one or more service management functions 512 configured to manage the specific services of the multi-cloud mesh 102 and/or MCN (configurable), and one or more APIs 514 for communicating with devices in the multi-cloud mesh 102 and/or MCN and causing various controller functions to occur.

In some examples, the NMS 124 may include one or more of a dashboard 206, a tag component 208, and/or a validation system 210. In some examples, the NMS 124 may include additional or fewer components.

The dashboard 206 may comprise one or more application(s) and/or API(s) that are provided by a service provider of the multi-cloud mesh (e.g., such as Cisco) to enable a customer to interface with the network management system and generate tags for various cloud objects. In some examples, the dashboard may enable the user to provide input to create, edit, and/or delete tag(s). In some examples, the dashboard enables the customer to tag cloud object(s) across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the vPoPs that are tagged as “blue” may then be interconnected with each other, whether vPoP is connected via AWS or Azure, and/or whether the vPoP is connected to an on premises data center (e.g., such as via a catalyst switch or a Meraki switch).

In some examples, the NMS may store and track tags associated with the multi-cloud mesh and/or cloud objects. For instance, the NMS may store mappings between various tags, CSPs, cloud objects, identifier(s), etc. in a database of the multi-cloud mesh and/or in memory of the NMS. The NMS may update the mappings based on changes made to tag value(s). As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

The tag component 208 may be configured to generate, track, and manage tags. For instance, the tag component may be incorporated as part of the NMS, included in a dashboard, and/or included as part application on a user device of a customer (e.g., outside of the multi-cloud mesh). For instance, the tag component may receive input from the dashboard. The tag component may be configured to use the input to create a signed tag associated with a cloud object. For instance, the customer may provide input that includes values for one or more fields (e.g., tag name, tag value, object ID, nonce value, etc.) of a tag. The cloud object(s) may include network elements such as VPCs, VNETs, subnet(s), instances, network interfaces, or any other object. The tag component may generate a signed tag based on the values input by the customer. In some examples, the signature may be generated by the tag component at the user device (e.g., such as by the application). In other examples, such as where the application is integrated as part of the NMS, the NMS may generate the signed tag via the tag component.

In some examples, the tag component 208 may include one or more of the values (e.g., such as tag name, VPNID, nonce, etc.) in a signature for the signed tag. In some examples, a name of the entity or an identifier of the entity may also be included in the signature. In some examples, the tag may include a nonce value. The nonce value may be a value added by the customer or a value generated by a service provider of the multi-cloud mesh (e.g., Cisco). The signature may comprise a cryptographical signature and/or may be hashed using any suitable hashing technique. Accordingly, by including the one or more values in the signature of the tag, the tag component may ensure that the signature is unable to be copied from one network to another. For instance, by including the nonce value, the system may ensure that even where the same hashing algorithm is run with known values of the tag being the same, the hashed value of the signed tag will still be different. Accordingly, the system may provide the ability to trust cloud objects across the CSPs.

In some examples, the tag component 208 may enable the user to edit one or more values of the tag. For instance, a user may update a value of one or more of the fields of the tag (e.g., such as the name, nonce value, etc.). As noted above, under existing techniques changing a value of a tag could provide access to network(s) the user should not have access to. For instance, a user may take a valid or previously used tag value and replay it, resulting in the user gaining access to networks and/or cloud objects they should not have access to.

Unlike existing techniques, by the tag component may, when a change to a tag value is made, determine whether the change is valid and authorized. For instance, the tag component may determine whether the change in the tag value will result in the user accessing a new network. In this example, the system may determine, based on network policies and/or security policies, whether the user is authorized to access the new network. Where the system determines that the user is not authorized to access the new network, the system may indicate that the change in the tag value is invalid. In this example, the system may ignore the new invalid tag and may continue to allow traffic from the cloud object using the previous valid tag. Additionally, the system may output an alert to the user via the dashboard indicating the new tag is invalid. Accordingly, the system may prevent users from other users of the MCN and/or cloud objects with IAM roles from changing tag values and gaining access to networks they shouldn't, thereby improving security within the MCN.

In some examples, such as where the tag component is implemented on a user device of a customer (e.g., as part of an application, etc.), the tag component may, once the tag is generated, send the tag to a cloud object (e.g., such as a VPC of the user running in a CSP) via an API (e.g., such as an AWS API) for storage and use. The VPC at the CSP may be associated with a customer account and may store the tag in memory and utilize the tag in connection with the cloud object (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new cloud object.

In some examples, the tag component may be configured to encrypt the tag signature using a private key, where the NMS or a validation system stores a corresponding public key used to decrypt the signature. In some examples, the tag component may be configured to utilize one or more machine learning and/or artificial intelligence models to generate the signed tags and/or encrypt the signed tags.

In some examples, the tag component may be configured or included as part of a trusted application. For instance, the trusted application may correspond to a third-party application that enables the user to write tags for cloud object(s) within the MCN. In some examples, the trusted application may include machine learning model(s) and/or artificial intelligence model(s).

In some examples, the tag component may be configured to read tags received and/or generated at the user device. For instance, the tag component may receive, via the dashboard, application, and/or cloud object, an indication of a new tag created by the user. The tag component may be configured to utilize the validation system to validate the tag.

In some examples, the tag component 208 may comprise models trained to generate and/or sign tags for cloud objects. For instance, the models may be trained based on one or more of tags associated with a user account of the user, open-sourced data, feedback received from a network administrator of the user account indicating acceptance, rejection, or changes to the generated tag.

In some examples, the tag component 208 may comprise one or more pre-trained models and/or pre-trained weighted models. In some examples, the artificial intelligence models are pre-trained using machine learning techniques. In some examples, the NMS 124 and/or tag component 208 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the tag component 208 may update the one or more machine learning models based on feedback received from the NMS 124, outputs from the machine learning models, and/or a network administrator.

The validation system 210 may be configured to validate signatures of tags. For instance, the validation system may correspond to a third-party system that is outside of the multi-cloud mesh and/or a system that is integrated as part of the NMS and/or multi-cloud mesh. In some examples, the validation system 210 may correspond to a certificate authority or other security system that stores public key(s), credential(s), certificate(s), etc. associated with application(s) or other network elements. In some examples, the validation system may store public key(s) associated with the tag(s) and/or application(s). The validation system may be configured to receive a signed tag, a cryptographical signature, and/or an encrypted signature of a tag from the tag component. The validation system may provide, to the tag component and based on the signature, a public key associated with the application. The tag component may validate that the tag is signed by the particular application and verify that the NMS can trust the application.

In some examples, the system may distribute mapping(s) to vPoP(s) once an application and/or tag is validated. For instance, the system may store mappings between the tags of incoming tunnel(s) and CIDR(s) to equivalent VPNID, SGTs, etc. In some examples, the system may distribute the mapping to relevant vPoP(s) (e.g., a subset of the vPoP(s) that will receive traffic associated with a particular tag), such that not all vPoP(s) store mappings for every cloud object, thereby reducing memory and storage utilized by the multi-cloud mesh.

The NMS 124 may further include a data store 516, such as long-term storage, that stores communication libraries 518 for the different communication protocols that the NMS 124 is configured to use or perform. Additionally, the data store 516 may include network topology data 520, such as a model representing the layout of the network components in the MCN and/or multi-cloud mesh 102 and/or data indicating available bandwidth, available CPU, delay between nodes, computing capacity, processor architecture, processor type(s), etc. The data store 516 may store policies 522 that include, but are not limited to, network policy(ies), network controller policy(ies), security data associated with the network, security policies configured for the network, agreement(s) and/or policies between entities, firewall policies, firewall configuration data, network configuration policies, network configuration data, security posture data, organization and/or entity policies, filtering policies, and/or compliance policies configured for the network. The data store 516 may store mapping(s)/data 524 including metadata, security data, identifier(s) (e.g., user, application ID, object ID, entity ID, tunnel ID, CIDR, SGT(s), etc.), routing protocol data, performance data, traffic data, flow logs, instruction data, location data, telemetry data, or any other data, metadata, and/or information described herein.

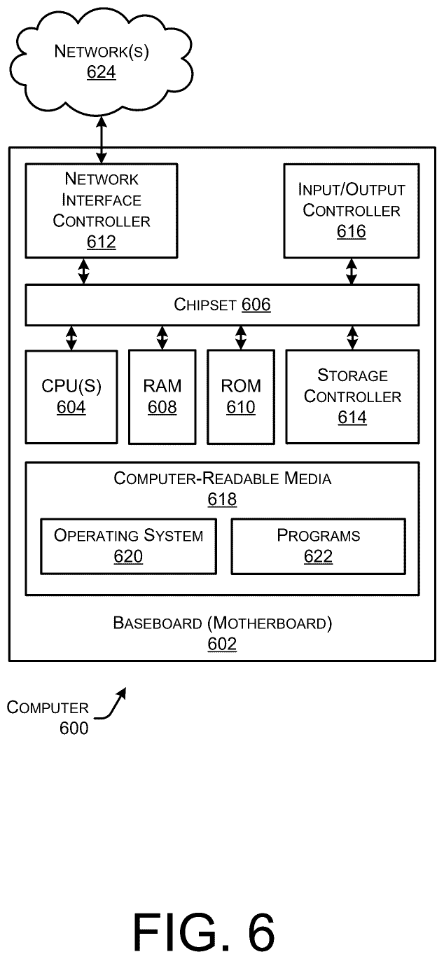

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a NMS 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs 604”) operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 624. The network(s) 624 may correspond to internet 122, the multi-cloud mesh 102, etc. The chipset 606 can include functionality for providing network connectivity through a NIC 612, such as a gigabit Ethernet adapter. The NIC 612 is capable of connecting the computer 600 to other computing devices over the network(s) 624. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the NMS 124, and/or any components included therein, may be supported by one or more devices similar to computer 600. Stated otherwise, some or all of the operations performed by the NMS 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-6. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a NMS 124, and/or any other device. The computer 600 may include one or more hardware processors (processor(s), such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the NMS 124, and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving input associated with a tag of a cloud object in the MCN, the cloud object being associated with a cloud account; determining, based in part on the input, that the input associated with the tag is valid; determining, based on the tag, one or more mappings between the tag and one of a tunnel or a classless inter domain routing (CIDR) group; determining, based on the one or more mappings, one or more virtual points of presence (vPoPs) within the MCN; and sending, to the one or more vPoPs, the one or more mappings.

In this way, the computer 600 may enable users to customize tags of cloud objects utilizing a dashboard or trusted customer application. By utilizing tag signatures that include fields of the tag within the signature, the system may prevent a customer from tampering or changing tag values and gaining access to networks they should not have access to. By storing the signed tags within the network elements (e.g., VPCs) at the cloud service provider, the system reduces the amount of memory and network bandwidth utilized by the NMS and multi-cloud mesh 102 for tracking and managing tags, thereby improving scalability of the multi-cloud mesh 102 and enabling integration in environments where network elements are created and destroyed frequently (e.g., such as terraformed environments). Moreover, by utilizing nonce values as well as other tag values when generating the signed tag, the system may ensure that even where the same hashing algorithm is run and where the known fields of a tag have the same values, the hash of the tag may still generate different hash values, thereby generating different signed tags, thereby enabling the system to more securely validate and track tags within the MCN.

Further, unlike existing techniques, by the tag component may, when a change to a tag value is made, determine whether the change is valid and authorized. For instance, the tag component may determine whether the change in the tag value will result in the user accessing a new network. In this example, the system may determine, based on network policies and/or security policies, whether the user is authorized to access the new network. Where the system determines that the user is not authorized to access the new network, the system may indicate that the change in the tag value is invalid. In this example, the system may ignore the new invalid tag and may continue to allow traffic from the cloud object using the previous valid tag. Additionally, the system may output an alert to the user via the dashboard indicating the new tag is invalid. Accordingly, the system may prevent users from other users of the MCN and/or cloud objects with IAM roles from changing tag values and gaining access to networks they shouldn't, thereby improving security within the MCN.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of providing zero trust tagging of cloud objects in a multi-cloud network (MCN), comprising:
receiving input associated with a tag of a cloud object in the MCN, the cloud object being associated with a cloud account;
determining, based in part on the input, that the input associated with the tag is valid;
determining, based on the tag, one or more mappings between the tag and one of a tunnel or a classless inter domain routing (CIDR) group;
determining, based on the one or more mappings, one or more virtual points of presence (vPoPs) within the MCN; and
sending, to the one or more vPoPs, the one or more mappings.

2. The method of claim 1, further comprising:
receiving, by a vPoP, a request to form a new tunnel or a new CIDR with the cloud object, the request comprising the tag;
determining, by the vPoP, that the tag is mapped to the new tunnel or the new CIDR; and
forming, by the vPoP, a secure connection with the cloud object.

3. The method of claim 1, wherein the cloud object comprises one of a virtual private cloud, a virtual network, a network interface, an instance, or a subnet associated with the cloud account.

4. The method of claim 1, wherein the tag comprises one or more fields including a tag name, a tag value, a time stamp, an object identifier, an entity identifier, or a nonce value.

5. The method of claim 4, wherein the tag is generated and signed by an application associated with a cloud service provider of the cloud account, wherein generating the tag comprises:
receiving second input via the application comprising values associated with the one or more fields; and
signing, by the application, the one or more fields of the tag to generate a cryptographical signature.

6. The method of claim 5, wherein the cryptographical signature is based on hashing the tag name, cloud object identifier, and an identifier of an entity.

7. The method of claim 1, further comprising:
receiving second input comprising an instruction to edit the tag and generate an updated tag associated with the cloud object;
determining, based on the second input, that the updated tag is invalid;
refraining from distributing the updated tag to the one or more vPoPs; and
enabling traffic flow between the cloud object and the MCN using the tag.

8. The method of claim 7, wherein determining the updated tag is invalid is based on or more of:
a value of one or more fields in the updated tag being replayed or associated with a previously used value;
a role of a user providing the input; or
a violation of a security policy associated with the value of the updated tag or the role of the user.

9. The method of claim 7, further comprising:
generating an alert associated with the updated tag, the alert indicating the updated tag is invalid; and
sending the alert to a user device for display.

10. The method of claim 1, wherein the input is received from an application on a user device, and wherein determining the input is valid comprises:
reading, by a network management system (NMS) of the MCN and from the cloud account, a signature of the tag;
validating, based on accessing a verification system, the signature of the tag as being generated by the application; and
based on validating the signature, storing an indication that the application is a trusted application in association with the tag.

11. A system comprising:
one or more processors; and
one or more computer-readable media storing instructions that, when executed by the one or more processors, cause the one or more processors to perform operations comprising:
receiving input associated with a tag of a cloud object in a multi-cloud network (MCN), the cloud object being associated with a cloud account;
determining, based in part on the input, that the input associated with the tag is valid;
determining, based on the tag, one or more mappings between the tag and one of a tunnel or a classless inter domain routing (CIDR) group;
determining, based on the one or more mappings, one or more virtual points of presence (vPoPs) within the MCN; and
sending, to the one or more vPoPs, the one or more mappings.

12. The system of claim 11, wherein the cloud object comprises one of a virtual private cloud, a virtual network, a network interface, an instance, or a subnet associated with the cloud account.

13. The system of claim 11, wherein the tag comprises one or more fields including a tag name, a tag value, a time stamp, an object identifier, an entity identifier, or a nonce value.

14. The system of claim 13, wherein the tag is generated and signed by an application associated with a cloud service provider of the cloud account, wherein generating the tag comprises:
receiving second input via the application comprising values associated with the one or more fields; and
signing, by the application, the one or more fields of the tag to generate a cryptographical signature.

15. The system of claim 14, wherein the cryptographical signature is based on hashing the tag name, cloud object identifier, and an identifier of an entity.

16. The system of claim 11, the operations further comprising:
receiving second input comprising an instruction to edit the tag and generate an updated tag associated with the cloud object;
determining, based on the second input, that the updated tag is invalid;
refraining from distributing the updated tag to the one or more vPoPs; and
enabling traffic flow between the cloud object and the MCN using the tag.

17. The system of claim 16, wherein determining the updated tag is invalid is based on or more of:
a value of one or more fields in the updated tag being replayed or associated with a previously used value;
a role of a user providing the input; or
a violation of a security policy associated with the value of the updated tag or the role of the user.

18. The system of claim 17, the operations further comprising:
generating an alert associated with the updated tag, the alert indicating the updated tag is invalid; and
sending the alert to a user device for display.

19. One or more non-transitory computer-readable media maintaining instructions that, when executed by one or more processors, program the one or more processors to perform operations comprising:
receiving input associated with a tag of a cloud object in a multi-cloud network (MCN), the cloud object being associated with a cloud account;
determining, based in part on the input, that the input associated with the tag is valid;
determining, based on the tag, one or more mappings between the tag and one of a tunnel or a classless inter domain routing (CIDR) group;
determining, based on the one or more mappings, one or more virtual points of presence (vPoPs) within the MCN; and
sending, to the one or more vPoPs, the one or more mappings.

20. The one or more non-transitory computer-readable media of claim 19, wherein the input is received from an application on a user device, and wherein determining the input is valid comprises:
reading, by a network management system (NMS) of the MCN and from the cloud account, a signature of the tag;
validating, based on accessing a verification system, the signature of the tag as being generated by the application; and
based on validating the signature, storing an indication that the application is a trusted application in association with the tag.
